(19) United States
(12) Patent Application Publication
(10) Pub. No.: US 2025/0283489 A1
(43) Pub. Date: Sep. 11, 2025

(54) ABNORMALITY DIAGNOSIS SYSTEM

(71) Applicant: TOYOTA JIDOSHA KABUSHIKI KAISHA, Toyota-shi (JP)

(72) Inventors: Hideaki BUNAZAWA, Nagoya-shi (JP); Mashu YAMAMOTO, Takahama-shi (JP); Atsushi TABATA, Okazaki-shi (JP); Kunio SUZUKI, Tokyo (JP); Takuya SHINTATE, Tokyo (JP)

(21) Appl. No.: 19/058,030

(22) Filed: Feb. 20, 2025

(30) Foreign Application Priority Data
Mar. 8, 2024 (JP) 2024-035848

(51) Int. Cl. F15B 19/00

(52) U.S. Cl. CPC F15B 19/005

(57) ABSTRACT

An abnormality diagnosis system includes a storage and processing circuitry. The storage stores cluster data. The cluster data indicates a distribution of clusters by type of abnormality in a hydraulic pressure control device. The processing circuitry generates evaluation data on features in hydraulic pressure recorded while operating the hydraulic pressure control device to be evaluated in a diagnosis pattern. The processing circuitry determines whether an abnormality has occurred in the hydraulic pressure control device based on a result of determining which cluster in the cluster data each of the features at multiple time points in the evaluation data belongs to.

### CROSS-REFERENCE TO RELATED APPLICATIONS

This application is based upon and claims the benefit of priority from Japanese Patent Application No. 2024-035848, filed on Mar. 8, 2024, the entire contents of which are incorporated herein by reference.

### BACKGROUND

### 1. Field

The present disclosure relates to an abnormality diagnosis system for a hydraulic pressure control device.

### 2. Description of Related Art

Japanese Laid-Open Patent Publication No. 2021-085480 discloses an abnormality diagnosis system for identifying the cause of an abnormality in shift control of an automatic transmission. The abnormality diagnosis system determines the cause of the abnormality in the automatic transmission based on the aspects of transient changes in a rotational speed of the automatic transmission.

In a case where the determination is performed by observing the fluctuation of the rotational speed in the automatic transmission, there is a possibility that the cause of the abnormality cannot be identified. For example, it is difficult to determine a failure of a component in the hydraulic pressure control device of the automatic transmission from the fluctuation of the rotational speed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An abnormality diagnosis system according to an aspect of the present disclosure includes processing circuitry and a storage. The storage of the abnormality diagnosis system stores cluster data. The cluster data indicates a distribution of clusters data by type of abnormality for features at multiple time points. The cluster data is generated by acquiring, a number of times, data on the features for fluctuation of hydraulic pressure obtained when operating, in a predetermined diagnosis pattern, a hydraulic pressure control device with an identified abnormality status and an identified type of abnormality. The processing circuitry of the abnormality diagnosis system is configured to generate, as evaluation data, data on the features in hydraulic pressure that is recorded while operating the hydraulic pressure control device to be evaluated in the diagnosis pattern. The processing circuitry of the abnormality diagnosis system is configured to determine whether an abnormality has occurred in the hydraulic pressure control device based on a result of determining which cluster in the cluster data each of the features at multiple time points in the evaluation data belongs to by comparing the features at the time points included in the evaluation data with the cluster data.

The decision boundary for determining which cluster the feature in the evaluation data belongs to may be determined using a machine learning algorithm such as a support vector machine.

The abnormality diagnosis system performs a determination using the data on the fluctuation of the hydraulic pressure of the hydraulic pressure control device. This allows the abnormality diagnosis system to acquire changes in the behavior of a hydraulic pressure resulting from an abnormality and determine that an abnormality has occurred in the hydraulic pressure control device.

Other features and aspects will be apparent from the following detailed description, the drawings, and the claims.

### BRIEF DESCRIPTION OF THE DRAWINGS

FIG. 1 is a schematic diagram showing an embodiment of an abnormality diagnosis system and a hydraulic pressure control device to be diagnosed.

FIG. 2 is a schematic diagram showing a configuration of the hydraulic pressure control device.

FIG. 3 is a graph showing an example of a diagnosis pattern.

FIG. 4 is a graph showing an example of clustering.

FIG. 5 is a flowchart showing the flow of processes executed by the abnormality diagnosis system.

FIG. 6 is a table showing the result of clustering.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order.

Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

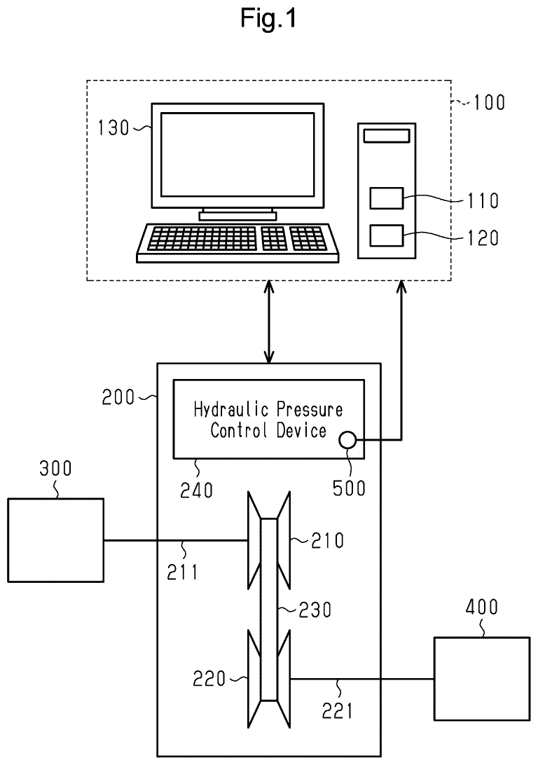

Hereinafter, an embodiment of the abnormality diagnosis system 100 will be described with reference to FIGS. 1 to 6.

### Configuration of Abnormality Diagnosis System 100

FIG. 1 shows the abnormality diagnosis system 100 and an automatic transmission 200 including a hydraulic pressure control device 240 to be diagnosed. When diagnosing the hydraulic pressure control device 240, as shown in FIG. 1, the abnormality diagnosis system 100 is connected to the automatic transmission 200. The abnormality diagnosis system 100 diagnoses the hydraulic pressure control device 240 by operating the hydraulic pressure control device 240 in a predetermined diagnosis pattern.

As shown in FIG. 1, the abnormality diagnosis system 100 includes processing circuitry 110, a storage 120, and a display 130. The processing circuitry 110 includes a CPU that executes processing in accordance with a program, and a ROM in which the program is stored. The storage 120 stores data. The abnormality diagnosis system 100 is, for example, a personal computer or a workstation.

### Configuration of Automatic Transmission 200

The automatic transmission 200 including the hydraulic pressure control device 240 to be inspected is mounted on, for example, an automobile. In FIG. 1, a continuously variable transmission is shown as an example of the automatic transmission 200. The automatic transmission 200 includes a first pulley 210, a second pulley 220, and a belt 230 wound around the first pulley 210 and the second pulley 220. The first pulley 210 is connected to an input shaft 211. The second pulley 220 is connected to an output shaft 221. The automatic transmission 200 transmits a driving force via a belt 230. In the automatic transmission 200, the hydraulic pressure control device 240 controls a first hydraulic pressure Pp supplied to the first pulley 210 and a second hydraulic pressure Ps supplied to the second pulley 220. Accordingly, the winding radius of the belt 230 on each of the first pulley 210 and the second pulley 220 changes. That is, the hydraulic pressure control device 240 changes the gear ratio of the automatic transmission 200 by changing the winding radius of the belt 230.

When diagnosing the hydraulic pressure control device 240, a drive motor 300 is connected to the input shaft 211, and a load motor 400 is connected to the output shaft 221. Hydraulic pressure sensors 500 that detect the hydraulic pressure of each part are connected to the hydraulic pressure control device 240. The diagnosis of the hydraulic pressure control device 240 is performed, for example, as a pre-shipment inspection after the automatic transmission 200 is manufactured. The drive motor 300 reproduces an input of the driving force to the automatic transmission 200 from a driving power source for an automobile. The load motor 400 reproduces a load acting on the automatic transmission 200.

### Configuration of Hydraulic Pressure Control Device 240

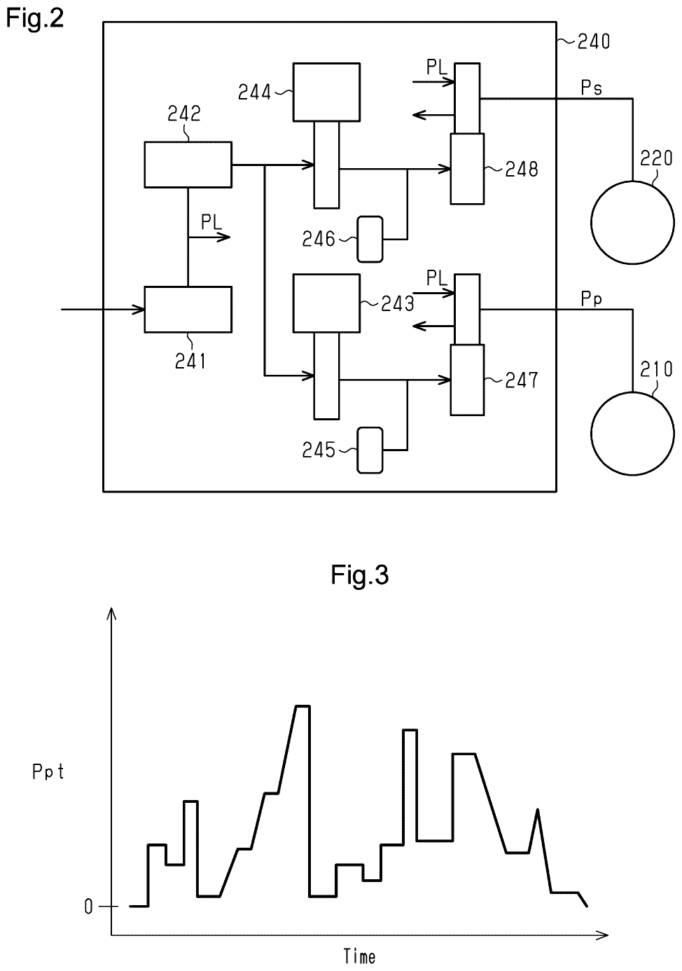

As shown in FIG. 2, the hydraulic pressure control device 240 includes a regulator valve 241, a modulator valve 242, a first control valve 247, and a second control valve 248. The hydraulic pressure control device 240 includes a first linear solenoid valve 243, a second linear solenoid valve 244, a first hydraulic damper 245, and a second hydraulic damper 246.

The regulator valve 241 regulates the hydraulic pressure of the oil supplied from the oil pump. The hydraulic pressure regulated by the regulator valve 241 is a line pressure PL. The oil regulated to the line pressure PL is supplied to the first control valve 247 and the second control valve 248. The hydraulic pressure adjusted to the line pressure PL is also supplied to the modulator valve 242.

The first control valve 247 supplies the oil regulated to the line pressure PL to the first pulley 210. The first control valve 247 controls the amount of oil supplied to the first pulley 210. The first control valve 247 increases the first hydraulic pressure Pp by supplying the oil regulated to the line pressure PL to the first pulley 210. The first control valve 247 controls the amount of oil discharged from the first pulley 210. The first control valve 247 lowers the first hydraulic pressure Pp by discharging oil from the first pulley 210.

The second control valve 248 supplies the oil regulated to the line pressure PL to the second pulley 220. The second control valve 248 controls the amount of oil to be supplied to the second pulley 220. The second control valve 248 increases the second hydraulic pressure Ps by supplying the oil regulated to the line pressure PL to the second pulley 220. The second control valve 248 also controls the amount of oil discharged from the second pulley 220. The second control valve 248 lowers the second hydraulic pressure Ps by discharging oil from the second pulley 220.

When the first hydraulic pressure Pp is increased and the second hydraulic pressure Ps is decreased, the winding radius of the belt 230 around the first pulley 210 increases and the winding radius of the belt 230 around the second pulley 220 decreases. When the second hydraulic pressure Ps is increased and the first hydraulic pressure Pp is decreased, the winding radius of the belt 230 around the second pulley 220 increases and the winding radius of the belt 230 around the first pulley 210 decreases. In this manner, the hydraulic pressure control device 240 changes the gear ratio in the automatic transmission 200.

The first control valve 247 and the second control valve 248 are each controlled by a signal hydraulic pressure. The modulator valve 242 regulates the line pressure PL to the signal hydraulic pressure. The oil adjusted to the signal hydraulic pressure is supplied to the first linear solenoid valve 243 and the second linear solenoid valve 244.

The first linear solenoid valve 243 controls the signal hydraulic pressure supplied to the first control valve 247. The second linear solenoid valve 244 controls the signal hydraulic pressure supplied to the second control valve 248. The signal hydraulic pressure supplied to the first control valve 247 is controlled by opening and closing the first linear solenoid valve 243. The signal hydraulic pressure supplied to the second control valve 248 is controlled by opening and closing the second linear solenoid valve 244.

The first hydraulic damper 245 is provided in an oil passage connecting the first linear solenoid valve 243 to the first control valve 247. The second hydraulic damper 246 is provided in an oil passage connecting the second linear solenoid valve 244 to the second control valve 248.

### Cluster Data

Cluster data is stored in the storage 120 of the abnormality diagnosis system 100. The cluster data is generated by acquiring, a number of times, the data on the features for the fluctuation of hydraulic pressure obtained when operating, in a predetermined diagnosis pattern, the hydraulic pressure control device 240 with an identified abnormality status and an identified type of abnormality. The cluster data indicates the distribution of clusters by type of abnormality for each feature at multiple times points in the predetermined diagnosis pattern. To generate the reference cluster data, the hydraulic pressure is measured while operating the hydraulic pressure control device 240 in the predetermined diagnosis pattern. For example, the line pressure PL, the first hydraulic pressure Pp, and the second hydraulic pressure Ps among the hydraulic pressures at multiple parts in the hydraulic pressure control device 240 are measured.

FIG. 3 shows changes in a target hydraulic pressure Ppt of the first hydraulic pressure Pp in the predetermined diagnosis pattern. The predetermined diagnosis pattern is defined by a target hydraulic pressure PLt of the line pressure PL, the target hydraulic pressure Ppt of the first hydraulic pressure Pp, and a target hydraulic pressure Pst of the second hydraulic pressure Ps. The predetermined diagnosis pattern is defined such that the line pressure PL, the first hydraulic pressure Pp, and the second hydraulic pressure Ps are fluctuated over a predetermined period so as to diagnose an abnormality in each portion of the hydraulic pressure control device 240 from the changes in the measured hydraulic pressure. The target hydraulic pressure PLt of the line pressure PL, the target hydraulic pressure Ppt of the first hydraulic pressure Pp, and the target hydraulic pressure Pst of the second hydraulic pressure Ps in the predetermined diagnosis pattern have different fluctuation patterns.

The actual hydraulic pressure varies with a delay with respect to the fluctuation of the target hydraulic pressure. The actual hydraulic pressure may overshoot the target hydraulic pressure. Instead of immediately converging to the target hydraulic pressure, the actual hydraulic pressure may oscillate up and down across the target hydraulic pressure until it converges to the target hydraulic pressure. The data indicating the changes in differential pressure between the target hydraulic pressure and the measured hydraulic pressure includes information on the delay, overshoot, and oscillation of the actual hydraulic pressure with respect to the target hydraulic pressure. Such delay, overshoot, and oscillation occur even in the hydraulic pressure control device 240 in which no abnormality has occurred.

In the predetermined diagnosis pattern, a time is divided into periods in accordance with the type of abnormality to be determined, and in each time period, the hydraulic pressures at multiple parts controlled by the hydraulic pressure control device 240 are controlled in a pattern suitable for determining the corresponding abnormality. The cluster data is generated by repeatedly measuring the line pressure PL, the first hydraulic pressure Pp, and the second hydraulic pressure Ps a number of times while operating the hydraulic pressure control device 240 in the predetermined diagnosis pattern. The cluster data is generated using the hydraulic pressure control device 240 in which the abnormality to be determined has occurred, in addition to the hydraulic pressure control device 240 in which no abnormality has occurred.

For example, each hydraulic pressure is measured while the hydraulic pressure control device 240 in which no abnormality has occurred is operated in the predetermined diagnosis pattern. By performing this measurement a predetermined number of times, the data on the cluster C_0 in a state where no abnormality has occurred is acquired. The data on the cluster C_1 in the state where the abnormality has occurred in the first hydraulic damper 245 is acquired by similarly performing the measurement the predetermined number of times using the hydraulic pressure control device 240 in which the abnormality has occurred in the first hydraulic damper 245. The data on the cluster C_2 in the state where the abnormality has occurred in the second hydraulic damper 246 is acquired by similarly performing the measurement the predetermined number of times using the hydraulic pressure control device 240 in which the abnormality has occurred in the second hydraulic damper 246. The data on the cluster C_3 in the state where the abnormality has occurred in the first control valve 247 is acquired by similarly performing the measurement the predetermined number of times using the hydraulic pressure control device 240 in which the abnormality has occurred in the first control valve 247. The data on the cluster C_4 in the state where the abnormality has occurred in the second control valve 248 is acquired by similarly performing the measurement the predetermined number of times using the hydraulic pressure control device 240 in which the abnormality has occurred in the second control valve 248.

The cluster data is obtained by collecting the data on the features of fluctuation for each of the line pressure PL, the first hydraulic pressure Pp, and the second hydraulic pressure Ps so as to indicate the distribution for each type of abnormality. Examples of the features include an overshoot amount of the hydraulic pressure, a time constant indicating a response delay of the hydraulic pressure, the amplitude in oscillation of the hydraulic pressure, the frequency of the oscillation of the hydraulic pressure, and a damping coefficient of the oscillation of the hydraulic pressure. The cluster data is data in which the distribution of the features at multiple time points in the predetermined diagnosis pattern is classified for an abnormality status and the type of abnormality based on the data on the measured hydraulic pressure so as to indicate the distribution.

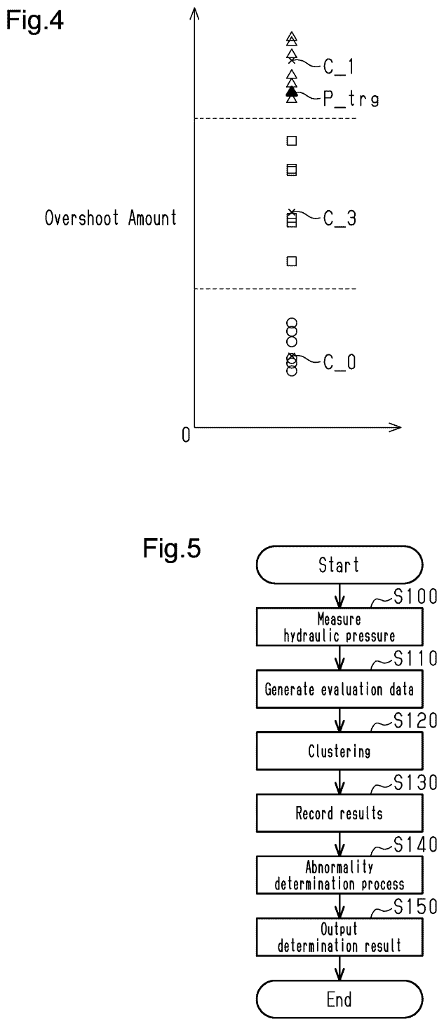

FIG. 4 is a part of the cluster data for the first hydraulic pressure Pp, showing the cluster distribution for the overshoot amount at a certain time point. In the example illustrated in FIG. 4, three clusters are illustrated in a one-dimensional coordinate system in which the overshoot amount is an explanatory variable. In FIG. 4, each data point in the overshoot amount of the cluster C_0 in a state where no abnormality has occurred is indicated by a blank circle. Each data point in the overshoot amount of the cluster C_1 in a state where an abnormality has occurred in the first hydraulic damper 245 is indicated by a blank triangle. Each data point in the overshoot amount of the cluster C_3 in a state where an abnormality has occurred in the first control valve 247 is indicated by a blank square. In FIG. 4, the centroid of each cluster is indicated by a cross mark.

The cluster data is data in which the distribution of clusters for each type of abnormality at multiple time points is collected for the features of the hydraulic pressures in the predetermined diagnosis pattern.

When the hydraulic pressure control device 240 is operated in the same diagnosis pattern, the hydraulic pressure varies depending on the abnormality status and the type of abnormality. Therefore, as shown in FIG. 4, the distribution of data in each feature varies depending on the abnormality status and the type of abnormality. Thus, the abnormality diagnosis system 100 generates, as evaluation data, data on the features in hydraulic pressure that is recorded while operating the hydraulic pressure control device 240 to be evaluated in the predetermined diagnosis pattern. Then, the abnormality diagnosis system 100 compares each of the features at multiple time points included in the evaluation data with the cluster data. In this manner, the abnormality diagnosis system 100 performs clustering to determine which cluster in the cluster data each of the features at multiple time points in the evaluation data belongs to. Then, the abnormality diagnosis system 100 performs abnormality diagnosis for determining whether an abnormality has occurred in the hydraulic pressure control device 240 to be evaluated based on the clustering result.

### Series of Processes Executed by Abnormality Diagnosis System 100

The flow of processes for abnormality diagnosis executed by the abnormality diagnosis system 100 will now be described with reference to FIG. 5. The series of processes illustrated in FIG. 5 is executed by the processing circuitry 110 of the abnormality diagnosis system 100.

As shown in FIG. 5, first, in the process of step S100, the processing circuitry 110 measures the hydraulic pressure while operating the hydraulic pressure control device 240 in the predetermined diagnosis pattern. The processing circuitry 110 measures the line pressure PL, the first hydraulic pressure Pp, and the second hydraulic pressure Ps while operating the hydraulic pressure control device 240 in accordance with the predetermined diagnosis pattern. The processing circuitry 110 records the measured time-series data on each hydraulic pressure in the storage 120 together with information on the time from the start of measurement.

In the process of step S110, the processing circuitry 110 analyzes the time-series data of each hydraulic pressure recorded in the storage 120 to generate the data on the feature of each hydraulic pressure as evaluation data. The evaluation data is related to an overshoot amount of the hydraulic pressure, a time constant indicating a response delay of the hydraulic pressure, the amplitude in oscillation of the hydraulic pressure, the frequency of the oscillation of the hydraulic pressure, and a damping coefficient of the oscillation of the hydraulic pressure. The processing circuitry 110 records the generated evaluation data in the storage 120. The evaluation data is data on the features for each time from the start of measurement.

In the process of step S120, the processing circuitry 110 compares the evaluation data with the reference cluster data to cluster the evaluation data. Specifically, the processing circuitry 110 compares the features at multiple time points included in the evaluation data with the cluster data, thereby determining which cluster in the cluster data each of the features at the time points in the evaluation data belongs to.

In FIG. 4, an overshoot amount P_trg in the evaluation data is indicated by a black triangle symbol. The processing circuitry 110 calculates, for example, the distance between the overshoot amount in the evaluation data and the centroid of each cluster. Then, the processing circuitry 110 determines that the overshoot amount in the evaluation data belongs to the cluster having the centroid at the closest distance. In the example illustrated in FIG. 4, the centroid closest to the overshoot amount P_trg in the evaluation data is the centroid of the cluster C_1. As a result, it is determined that the overshoot amount P_trg in the evaluation data belongs to the cluster C_1.

The clustering method is not limited to such a method of calculating the distance from the centroid. For example, the decision boundary for determining which cluster the feature in the evaluation data belongs to may be determined using a machine learning algorithm such as a support vector machine. The broken lines shown in FIG. 4 are examples of decision boundaries. In the example illustrated in FIG. 4, the overshoot amount P_trg in the evaluation data is located closer to the cluster C_1 than the decision boundary between the cluster C_1 and the cluster C_3. As a result, it is determined that the overshoot amount P_trg in the evaluation data belongs to the cluster C_1.

As described above, in step S120, the processing circuitry 110 determines which cluster in the cluster data each of the features at multiple time points in the evaluation data belongs to.

In the process of step S130, the processing circuitry 110 stores the clustering result in the storage 120.

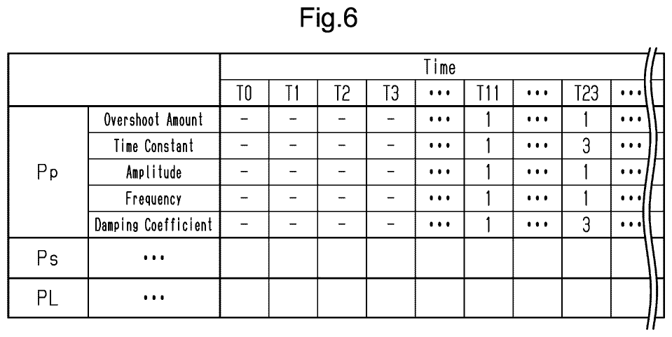

As illustrated in FIG. 6, the data on the clustering result stored in the storage 120 is information indicating which cluster the features of the hydraulic pressures are determined to belong to at the time points from the start of measurement. In FIG. 6, the portion that is determined to belong to the cluster C_1 is indicated by 1, the portion that is determined to belong to the cluster C_3 is indicated by 3, and the portion that cannot be determined to belong to any cluster is indicated by “-”. When the hydraulic pressure is in an equilibrium state, all the features are 0. Therefore, during the period in which the hydraulic pressure is in the equilibrium state in the diagnostic pattern, the processing circuitry 110 cannot determine which cluster the features of the evaluation data belong to. When the clusters in the cluster data overlap each other, the processing circuitry 110 cannot determine which cluster the features of the evaluation data belongs to. Although not shown in FIG. 6, the portion determined to belong to the cluster C_0 is indicated by 0, the portion determined to belong to the cluster C_2 is indicated by 2, and the portion determined to belong to the cluster C_4 is indicated by 4.

In the process of step S140, the processing circuitry 110 executes an abnormality determination process. In the abnormality determination process, the processing circuitry 110 determines whether an abnormality has occurred in the hydraulic pressure control device 240 to be evaluated with reference to the clustering result. For example, in a case where the number of times the features are determined to belong to the cluster C_0 is larger than the number of times of times the features are determined to belong to any other cluster, the processing circuitry 110 determines that no abnormality has occurred. For example, the processing circuitry 110 determines that an abnormality corresponding to the cluster, among the clusters C_1 to C_4, to which the features of the evaluation data are determined to belong the largest number of times has occurred.

In the predetermined diagnosis pattern, a time is divided into periods in accordance with the type of abnormality to be determined, and in each time period, the hydraulic pressures at multiple parts controlled by the hydraulic pressure control device 240 are controlled in a pattern suitable for determining the corresponding abnormality. Therefore, the abnormality determination process may be a process of determining the presence or absence of an abnormality and the type of abnormality by weighting each type of abnormality such that the result of clustering in a period suitable for determining the abnormality is particularly emphasized. The abnormality determination process may be a process using a pre-trained neural network that has been trained in advance through supervised learning so as to determine which abnormality has occurred by inputting data on the clustering result.

In the process of step S150, the processing circuitry 110 outputs the determination result diagnosed through the abnormality determination process. Specifically, the processing circuitry 110 displays the determination result on the display 130.

### Operation of Present Embodiment

The processing circuitry 110 of the abnormality diagnosis system 100 generates, as evaluation data, data on the features in hydraulic pressures that are recorded while operating the hydraulic pressure control device 240 to be evaluated in a diagnosis pattern (step S110). The processing circuitry 110 performs clustering to determine which cluster in the cluster data each of the features at multiple time points in the evaluation data belongs to (step S120). The processing circuitry 110 determines whether an abnormality has occurred in the hydraulic pressure control device 240 based on the clustering result (step S140).

In a case in which an abnormality has occurred in the hydraulic pressure control device 240, it indicates a hydraulic pressure fluctuation that is different from the hydraulic pressure fluctuation in a normal hydraulic pressure control device 240. Thus, when the hydraulic pressure control device 240 is operated in the predetermined diagnosis pattern, the data on features indicate changes corresponding to the abnormality status and the type of abnormality. The abnormality diagnosis system 100 determines which cluster each of the features at multiple time points in the evaluation data belongs to through comparison with the cluster data. The abnormality diagnosis system 100 determines whether an abnormality has occurred in the hydraulic pressure control device 240 based on the determination result.

### Advantages of Present Embodiment

(1) The abnormality diagnosis system 100 performs a determination using the data on the fluctuation of the hydraulic pressure of the hydraulic pressure control device 240. This allows the abnormality diagnosis system 100 to acquire changes in the behavior of a hydraulic pressure resulting from an abnormality and determine that an abnormality has occurred in the hydraulic pressure control device 240.
(2) The processing circuitry 110 outputs, when determining that an abnormality has occurred, information on a type of the abnormality that has occurred. This allows the abnormality diagnosis system 100 to identify the type of an abnormality that has occurred.
(3) The features include an overshoot amount of the hydraulic pressure, a time constant indicating a response delay of the hydraulic pressure, the amplitude in oscillation of the hydraulic pressure, the frequency of the oscillation of the hydraulic pressure, and a damping coefficient of the oscillation of the hydraulic pressure. This allows the abnormality diagnosis system 100 to identify the abnormality status and the type of abnormality by acquiring the changes in how the hydraulic pressure fluctuates.
(4) In the diagnosis pattern, a time is divided into periods in accordance with the type of abnormality to be determined, and in each time period, the hydraulic pressures at multiple parts controlled by the hydraulic pressure control device 240 are controlled in a pattern suitable for determining the corresponding abnormality. The abnormality diagnosis system 100 controls the hydraulic pressures at multiples parts in a pattern suitable for determining each abnormality. This allows the abnormality diagnosis system 100 to identify the type of an abnormality more easily.
(5) The hydraulic pressures at the parts controlled by the hydraulic pressure control device 240 include the first hydraulic pressure Pp, which is a hydraulic pressure at the first pulley 210 of a continuously variable transmission, and the second hydraulic pressure Ps, which is a hydraulic pressure at the second pulley 220 of the continuously variable transmission. Thus allows the abnormality diagnosis system 100 to diagnose the hydraulic pressure control device 240 that controls the hydraulic pressure supplied to the first pulley 210 and the second pulley 220.

### Modifications

The present embodiment may be modified as follows. The present embodiment and the following modifications can be combined as long as they remain technically consistent with each other.

The abnormality diagnosis system 100 does not have to determine the type of abnormality. For example, the abnormality status and the data on the clustering result shown in FIG. 6 are output. This allows the abnormality diagnosis system 100 to provide information serving as a material for determining not only whether an abnormality has occurred but also the type of abnormality that has occurred. This information allows the operator to identify the type of an abnormality that has occurred.

The above-described abnormality diagnosis system 100 is configured to determine whether an abnormality has occurred in the hydraulic pressure control device 240, which controls a hydraulic pressure supplied to the first pulley 210 and the second pulley 220 in a continuously variable transmission. The hydraulic pressure control device 240 to be diagnosed is not limited to the hydraulic pressure control device 240 of the continuously variable transmission. The diagnosis target may be a hydraulic pressure control device of a stepped transmission. The diagnosis target is not limited to the hydraulic pressure control device of the automatic transmission.

In the above-described embodiment, the abnormality diagnosis system 100 includes the processing circuitry 110 and the storage 120, and executes software processing. However, this is merely exemplary. For example, the abnormality diagnosis system 100 may include a dedicated hardware circuit (such as ASIC) that executes at least part of the software processes executed in the above-described embodiment. That is, the abnormality diagnosis system 100 may have any one of the following configurations (A) to (C). (A) The abnormality diagnosis system 100 includes an execution device that executes all the processes in accordance with a program and a storage that stores the program. That is, the abnormality diagnosis system 100 includes a software execution device. (B) The abnormality diagnosis system 100 includes an execution device that executes some of the processes in accordance with a program, and a storage. Further, the abnormality diagnosis system 100 includes a dedicated hardware circuit that performs the remaining processes. (C) The abnormality diagnosis system 100 includes a dedicated hardware circuit that executes all the processes. There may be multiple software execution devices and/or dedicated hardware circuits. That is, the above processes may be executed by processing circuitry that includes at least one of a set of one or more software execution devices and a set of one or more dedicated hardware circuits. The storage (i.e., computer-readable medium) that stores a program includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An abnormality diagnosis system for a hydraulic pressure control device, the abnormality diagnosis system comprising:
processing circuitry; and
a storage, wherein
the storage stores cluster data, the cluster data indicating a distribution of clusters data by type of abnormality for features at multiple time points, the cluster data being generated by acquiring, a number of times, data on the features for fluctuation of hydraulic pressure obtained when operating, in a predetermined diagnosis pattern, a hydraulic pressure control device with an identified abnormality status and an identified type of abnormality, and
the processing circuitry is configured to:
generate, as evaluation data, data on the features in hydraulic pressure that is recorded while operating the hydraulic pressure control device to be evaluated in the diagnosis pattern; and
determine whether an abnormality has occurred in the hydraulic pressure control device based on a result of determining which cluster in the cluster data each of the features at multiple time points in the evaluation data belongs to by comparing the features at the time points included in the evaluation data with the cluster data.

2. The abnormality diagnosis system according to claim 1, wherein
the processing circuitry is configured to output, when determining that an abnormality has occurred, information on a type of the abnormality that has occurred.

3. The abnormality diagnosis system according to claim 1, wherein
the features include an overshoot amount of the hydraulic pressure, a time constant indicating a response delay of the hydraulic pressure, an amplitude in oscillation of the hydraulic pressure, a frequency of the oscillation of the hydraulic pressure, and a damping coefficient of the oscillation of the hydraulic pressure.

4. The abnormality diagnosis system according to claim 2, wherein
the diagnosis pattern divides a time into periods in accordance with a type of abnormality to be determined, and control, in each of the periods, hydraulic pressures at multiple parts controlled by the hydraulic pressure control device in a pattern suitable for determining a corresponding abnormality.

5. The abnormality diagnosis system according to claim 4, wherein
the hydraulic pressures at the parts controlled by the hydraulic pressure control device include a first hydraulic pressure and a second hydraulic pressure, the first hydraulic pressure being a hydraulic pressure at a first pulley of a continuously variable transmission, the second hydraulic pressure being a hydraulic pressure at a second pulley of the continuously variable transmission, and
the abnormality diagnosis system is configured to diagnose the hydraulic pressure control device that controls the hydraulic pressure supplied to the first pulley and the second pulley.
